(19) United States
(12) Patent Application Publication
(10) Pub. No.: US 2026/0303629 A1
(43) Pub. Date: Oct. 1, 2026

(54) NETWORK TRAFFIC TO IMAGE CONVERSION FOR DATA EXFILTRATION DETECTION

(71) Applicant: Check Point Software Technologies, Ltd., Tel Aviv (IL)

(72) Inventors: Ran BURDO, Kfar Vradim (IL); Shai Imanouel GROUNDMAN, Kiryat Ono (IL); Or Shaham, Rishon LeZion (IL)

(73) Assignee: Check Point Software Technologies, Ltd., Tel Aviv (IL)

(21) Appl. No.: 19/095,541

(22) Filed: Mar. 31, 2025

(51) Int. Cl. H04L 9/40

(52) U.S. Cl. CPC H04L 63/1425; H04L 63/1441

(57) ABSTRACT

A device and method are provided for transforming network traffic data into image representations for anomaly detection. Relevant data fields are extracted from received network traffic data. The network traffic data is separated into connection profiles based on associated data field values. The generated connection profiles are represented as connection feature vectors. The connection feature vectors are used to generate connection matrices. Each connection matrix is converted into a connection image that visually represents network activity. A neural network model processes the connection image and extracts target image features. An anomaly score is calculated by comparing these features against a set of reference image features. A notification indicating the presence or absence of an anomaly is output together with information indicating anomalous connection features of the network traffic data.

### TECHNICAL FIELD

The present disclosure generally relates to anomaly detection. More particularly, the present disclosure relates to converting network traffic data into image representations to facilitate anomaly detection in network connections.

### BACKGROUND

Anomaly detection plays a significant role in maintaining network security, optimizing performance, and identifying potential threats in network environments. As modern networks continue to expand in scale and complexity, the ability to effectively detect anomalies has become increasingly important. Anomalies in network traffic may indicate cyber threats, such as unauthorized access, malware infections, or data exfiltration attacks. Effective anomaly detection techniques enable organizations to mitigate security risks, improve incident response, and enhance network performance.

### SUMMARY

Traditional anomaly detection approaches rely heavily on numerical data analysis, statistical modeling, and heuristic-based methods to identify deviations from expected network behavior. These techniques involve analyzing packet headers, flow statistics, and metadata to detect irregularities. However, as network traffic becomes more sophisticated, traditional methods often struggle to accurately capture and classify complex patterns indicative of malicious activities.

Despite the advancements in conventional network anomaly detection methods, limitations persist. For example, numeric-based detection approaches struggle to identify subtle, high-dimensional patterns in network traffic data, particularly when dealing with encrypted traffic or obfuscated attack techniques. Many existing anomaly detection systems rely on raw network traffic data in its original numerical format, making it difficult to visualize complex patterns and relationships between different network entities. While recent artificial intelligence (AI) and machine learning (ML) models have shown strong performance in image-based anomaly detection tasks, these models require structured image data, which is not naturally available in traditional network traffic analysis. Without a more intuitive and detailed representation of network traffic, security systems may fail to detect sophisticated attacks, such as data exfiltration, insider threats, or coordinated cyber-attacks.

Given the limitations of traditional approaches, there is a need for innovative techniques that can enhance anomaly detection capabilities in network environments. Accordingly, aspects of the present disclosure relate to the transformation of network traffic data into image representations for anomaly detection by a neural network model. By representing network traffic data in a visual format, it is possible to make use of AI/ML models and leverage advanced image processing techniques to detect anomalies more accurately and effectively than traditional numeric data methods. This makes it possible to improve anomaly detection accuracy by allowing ML models to identify complex, high-dimensional patterns, and enhance cybersecurity defense mechanisms against sophisticated attacks, such as data exfiltration and insider threats. Additionally, image representations of network traffic can allow for better visualization of network traffic patterns, facilitating network monitoring and performance analysis by providing more intuitive representations of traffic behavior. In this way, it is possible to enhance defense mechanisms against malicious actors by improving anomaly detection.

The above summary is not intended to describe each illustrated embodiment or every implementation of the present disclosure.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 is a diagram illustrating an example hardware configuration of an anomaly detection system according to the embodiments of the present disclosure.

FIG. 2 is a flow diagram of an anomaly detection method according to the embodiments of the present disclosure.

FIG. 3 is a diagram illustrating an example of generating a connection image.

FIG. 4 is a diagram illustrating an example of creating connection profiles from network traffic data.

FIG. 5 is block diagram illustrating a neural network model training process.

FIG. 6 is a block diagram illustrating an anomaly score threshold determination process.

FIG. 7 illustrates example anomaly maps according to the embodiments of the present disclosure.

FIG. 8 illustrates an example computing architecture for executing the embodiments of the present disclosure.

### DETAILED DESCRIPTION

Hereinafter, embodiments of the present disclosure will be described with reference to the accompanying drawings. It should be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure. Additionally, it should be noted in the following description that the same reference numerals in different embodiments denote the same or similar features.

Aspects of the disclosure relate to providing a device and method for transforming network traffic data into image representations for anomaly detection by a neural network model. More particularly, aspects of the present disclosure relate to extracting relevant data fields from received network traffic data for multiple connections. The network traffic data is separated into connection profiles based on data field values of the extracted data fields. The generated connection profiles are represented in a vector format as a set of connection feature vectors, which are compressed using a value narrowing function. The narrowed vector is used to generate connection matrices through an outer product operation, and the matrix values of each connection matrix are scaled before the matrix is converted into a connection image that visually represents network activity. A neural network model then processes the connection image to extract target image features from image patches. An anomaly score is calculated by comparing these features against a set of reference image features. Based on the anomaly score, the system determines whether the network traffic for the connection is normal or anomalous. If the traffic is normal, a notification confirming the absence of anomalies may be generated. If an anomaly is detected, the system generates an anomaly map highlighting regions in the connection image that contain suspicious patterns. It then outputs a notification specifying which features of the connection are associated with the anomaly.

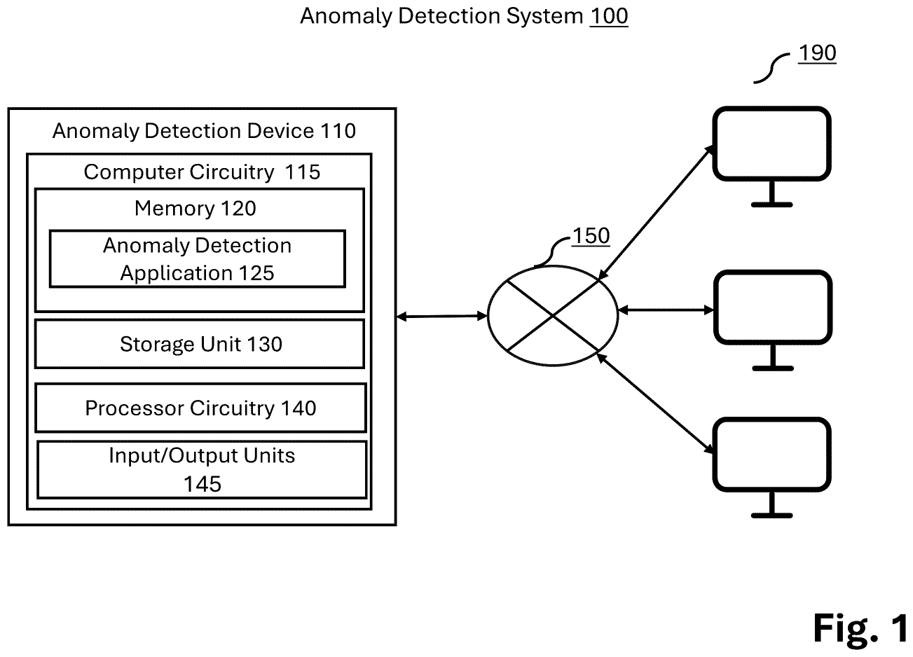

FIG. 1 illustrates an example hardware configuration of an anomaly detection system 100 according to the embodiments of the present disclosure. The anomaly detection system 100 includes an anomaly detection device 110 and one or more client devices 190 communicatively connected by a communication network 150. The anomaly detection device 110 includes computer circuitry 115 including a memory 120, a storage unit 130, processor circuitry 140, and input/output units 145. The memory 120 of the anomaly device 110 includes an anomaly detection application 125 configured to perform anomaly detection consistent with the embodiments of the present disclosure.

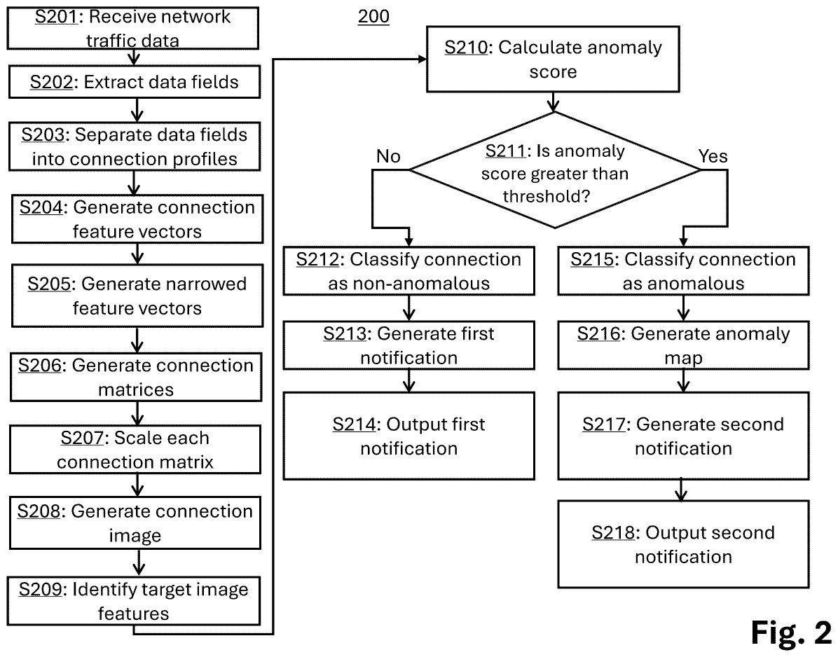

FIG. 2 is a flow diagram of an anomaly detection method 200 according to the embodiments of the present disclosure. The anomaly detection method 200 may be performed by the processor circuitry 140 of the anomaly detection device 110 by executing computer instructions of the anomaly detection application 125.

At Step S201, processor circuitry 140 of the asset detection device 100 receives a set of network traffic data for multiple connections. The processor circuitry 140 may receive the set of network traffic data from the one or more client devices 190. The set of network traffic data may be received in real-time or at scheduled intervals as part of a batch processing operation. For example, the set of network traffic data may be received from the one or more client devices 190 together with an anomaly detection request. The set of network traffic data may refer to any recorded or real-time information about communications occurring over a network. The set of network traffic data may include packet capture files such as PCAP files or log files (e.g., from servers).

Next, at Step S202, the processor circuitry 140 extracts a set of data fields from the set of network traffic data received in Step S201. Each data field of the set of data fields may be associated with a data field value. The set of data fields may refer to information defining the structure, source, destination, protocol, or payload of the set of network traffic data. The data field values may refer to the value of a specific attribute of the set of network traffic data. The processor circuitry 140 may extract the set of data fields using one or more packet analysis tools, parsing libraries, APIs, command-line processing, custom parsers, or the like.

The processor circuitry 140 could perform operations other than, or in addition to, the outer product for generating the connection matrix, such as dot products, cross-correlations, or concatenation layers depending on the desired analysis. Additionally, rather than a single step of feature vector creation, the processor circuitry 140 may employ multiple sequential encoders or hashing mechanisms to further transform the network traffic data.

Next, at Step S203, the processor circuitry 140 separates the set of data fields into a set of connection profiles based on the data field values. Here, the set of connection profiles may refer to data characterizing an associated connection of the multiple connections. Here, a connection refers to a logical session between two endpoints (e.g., a client and a server). The processor circuitry 140 may separate the set of data fields into the set of connection profiles by aggregating data field values for the set of network traffic data that correspond to an associated connection into a set of connection features. The set of connection features may refer to the sum of the aggregated data field values.

Next, at Step S204, the processor circuitry 140 generates a set of connection feature vectors by generating a connection feature vector for each connection of the multiple connections based on the set of connection features. The connection feature vector may represent the set of connection features as numerical information in a vector format. The processor circuitry 140 may generate the connection feature vector by transforming the set of connection features into a numerical format using one or more techniques including embeddings, normalization and standardization, hashing, frequency encoding, binary encoding, or the like.

Next, at Step S205, the processor circuitry 140 generates a set of narrowed feature vectors by applying a value narrowing function to the set of connection feature vectors. The value narrowing function is a function for compressing values of the connection feature vectors to a defined range. The value narrowing function may include a logarithmic function. As an example, the value narrowing function may be defined as:

$$np . log 1 p ( v ) = ln ( v + 1 ) , \qquad [ Equation 1 ]$$

where v is the connection feature vector. By applying the value narrowing function, the values of the connection feature vectors can be compressed to a smaller range, preventing outliers from disproportionately influencing the subsequent image generation.

Next, at Step S206, the processor circuitry 140 generates a set of connection matrices. The processor circuitry 140 generates the set of connection matrices by taking an outer product of each narrowed feature vector of the set of narrowed feature vectors with itself. Each connection matrix is made of a set of connection values, with each connection value being referred to as an entry in the connection matrix. Each connection value of the set of connection values is based on the value of one or more connection features of a particular narrowed feature vector of the set of narrowed feature vectors. For instance, the set of connection values may be obtained by taking the product of each connection feature of the set of connection features with itself. As an example, if the narrowed feature vector has 37 components, the connection matrix may be a 37×37 matrix, where each cell at index (i, j) corresponds to the product (e.g., the connection value) of the i-th and j-th connection features in the original 37 dimensional narrowed feature vector. Each connection value of the set of connection values is associated with one or more of the connection features of the set of connection features of the connection profile based on the one or more connection features of the narrowed feature vector used to compute the connection value.

Next, at Step S207, the processor circuitry 140 scales the set of connection matrices using a scaling function configured to scale the range of the connection values in the connection matrix. The processor circuitry 140 may scale the set of connection matrices using a min-max scaler. Applying a min-max scaler rescales the connection values of each connection matrix to a uniform range to facilitate transformation of the matrix to an image and ensure that the resulting connection image is only dependent on its corresponding narrowed feature vector rather than external scaling factors.

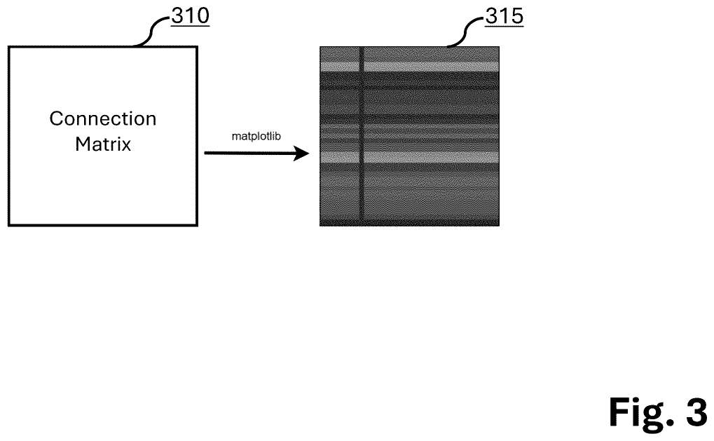

Next, at Step S208, the processor circuitry 140 generates a connection image for each connection matrix of the set of connection matrices by converting the connection values of each connection matrix to pixel representations. With reference to FIG. 3, an example of converting a connection matrix 310 to a connection image 315 is illustrated. As illustrated in FIG. 3, the processor circuitry 140 may generate the connection image 315 by using a function such as matplotlib.pyplot to convert the connection values of the connection matrix 310 to RGB pixel representations with a predetermined color map. For example, matplotlib.pyplot may convert the connection values of the connection matrix 310 to RGB pixel representations using a “viridis” color map.

The anomaly detection device 110 may execute Steps S206-S208 in parallel across multiple processor cores or on specialized hardware. For example, a graphics processing unit (GPU) may perform the outer product operations and matrix scaling for numerous narrowed feature vectors concurrently, significantly reducing overall processing latency.

Next, at Step S209, the processor circuitry 140 identifies a set of target image features for each connection image of the set of connection images. More particularly, the processor circuitry 140 identifies the set of target image features by applying a feature extractor of a trained neural network model to identify features in the connection image and to extract a set of target image features from each connection image based on the identified features. The target image features may refer to numerical representations that represent features including patterns, structures, and characteristics of the connection image. The processor circuitry 140 may extract the set of target image features by processing the connection image using a pre-trained convolutional neural network as part of an image-based anomaly detection technique (e.g., Patchcore). An intermediate layer of the convolutional neural network may extract the target image features from patches of the connection image. Here, the intermediate layer (e.g., layer 3 of the feature extractor in Patchcore) refers to a layer configured to capture spatial and contextual information from the patches of the connection image.

Next, at Step S210, the processor circuitry 140 calculates an anomaly score for each connection image of the set of connection images based on the extracted target image features. The anomaly score may refer to a numerical value (e.g., in a range of 0-100) that indicates the degree of deviation, aberration, or abnormality of the set of target image features with respect to a set of reference image features stored in a memory bank of the neural network model, where greater values indicate greater deviation and smaller values indicate less deviation.

The processor circuitry 140 may calculate the anomaly score by determining, for each target image feature of the set of target image features, a distance value representing a measure of similarity between the target image feature and a corresponding reference image feature of the set of reference image features stored in the memory bank of the neural network model, identifying a subset of the target image features having a distance value that achieves a predetermined distance threshold, and computing a weighted aggregation of the distance values associated with the identified subset of target image features. In this way, the anomaly score for each connection image is calculated as the result of the weighted distance of the target image features most distant from the reference image features saved in the memory bank.

Next, at Step S211, the processor circuitry 140 determines the relative relationship between the anomaly score calculated in Step S210 and a predetermined first anomaly score threshold. In the case that the anomaly score calculated in Step S210 is less than or equal to the first anomaly score threshold, the method 200 proceeds to Step S212. In the case that the anomaly score calculated in Step S210 is greater than the first anomaly score threshold, the method 200 proceeds to Step S215.

At Step S212, in the case that the anomaly score calculated in Step S210 is less than or equal to the first anomaly score threshold, the processor circuitry 140 classifies the associated connection of the set of network traffic data received in Step S201 as non-anomalous. Subsequently, at Step S213, the processor circuitry 140 generates a first notification indicating that the connection is non-anomalous, and outputs the first notification at Step S214. The classification of the connection as non-anomalous and the output of the first notification may be performed in real-time while the connection is in progress. Here, the processor circuitry 140 may output the first notification by transmitting the first notification to the one or more client devices 190 over the communication network 150.

In some embodiments, the classification of connections and the generation of notifications may be performed offline or in batch processing mode. In near real-time scenarios, the anomaly detection device 110 may utilize specialized hardware accelerators (e.g., GPUs or inference chips) to process the most recent incoming traffic. In offline settings, larger volumes of historical data can be processed periodically, facilitating trend analysis or forensic investigations of suspected intrusions.

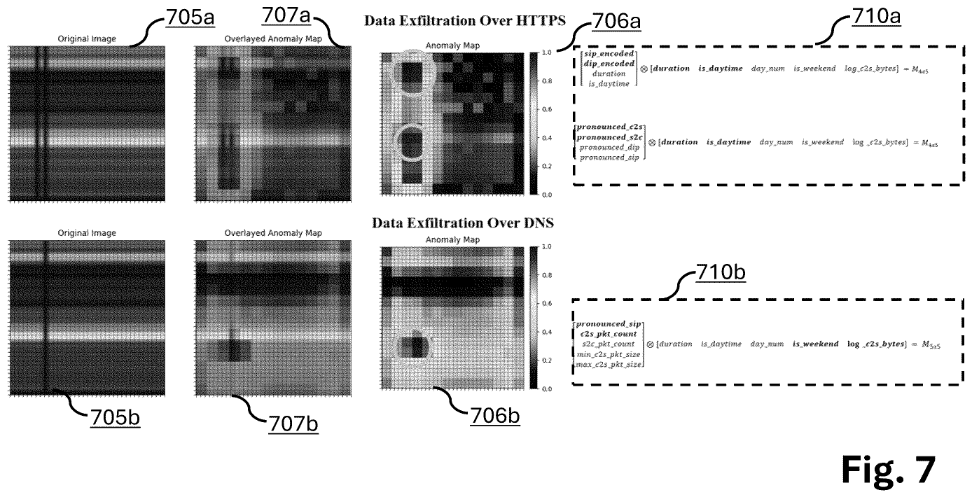

At Step S215, in the case that the anomaly score calculated in Step S210 is greater than the first anomaly score threshold, the processor circuitry 140 classifies the associated connection of the set of network traffic data received in Step S201 as anomalous. Subsequently, at Step S216, the processor circuitry 140 generates an anomaly map with respect to the connection image. The anomaly map is an image that indicates regions of the connection image that are associated with target image features having anomaly scores greater than the first anomaly score threshold. In this way, the most anomalous patches (regions) of the connection image can be identified. The processor circuitry 140 may generate the anomaly map by creating a heat map that depicts the regions of the connection image associated with target image features having greater anomaly scores with progressively greater visual emphasis, as illustrated in the example of FIG. 7.

Next, at Step S217, the processor circuitry 140 generates a second notification that indicates that the associated connection of the set of network traffic data received in Step S201 is anomalous. The second notification may indicate a subset of the set of connection features of the connection profile that are associated with target image features of the set of target image features having anomaly scores greater than a second anomaly score threshold (e.g., the most anomalous connection features). Next, at Step S218, the processor circuitry outputs the second notification. The classification of the connection as non-anomalous, the generation of the anomaly map, and the output of the second notification may be performed in real-time while the connection is in progress. Here, the processor circuitry 140 may output the second notification by transmitting the second notification to the one or more client devices 190 over the communication network 150.

More particularly, the processor circuitry 140 may generate the second notification by mapping regions of the anomaly map to the set of connection features of the connection profile based on the position of the connection values associated with the set of connection features in the connection matrix, and then identifying, from among the set of connection features, the subset of the set of connection features associated with target image features that achieve the second anomaly score threshold. As the pixels in the connection image may be RGB representations of the connection values in the connection matrix, and the connection values in the connection matrix in turn correspond to particular connection features of the connection profile, any region (e.g., patch) of the connection image can be directly mapped back to one or more particular connection features in the connection profile, and thus the data fields extracted from the network traffic data, based on the position of the corresponding connection values in the connection matrix. In this way, the second notification can provide insights to system administrators regarding which connection features of the set of network traffic data contributed the most to the anomaly detection.

The anomaly detection device 110 may log the anomalous connection images and their corresponding anomaly maps in a dedicated archive or “anomaly log.” This log can store relevant metadata such as timestamps, source/destination addresses, and the extracted anomalous feature subsets. Storing the images and associated analysis results enables long-term trend evaluation and retrospective investigations. The stored data may also be used to refine the reference image feature set (e.g., updating the memory bank as legitimate but previously unseen patterns are identified) or to support future training and threshold calibration.

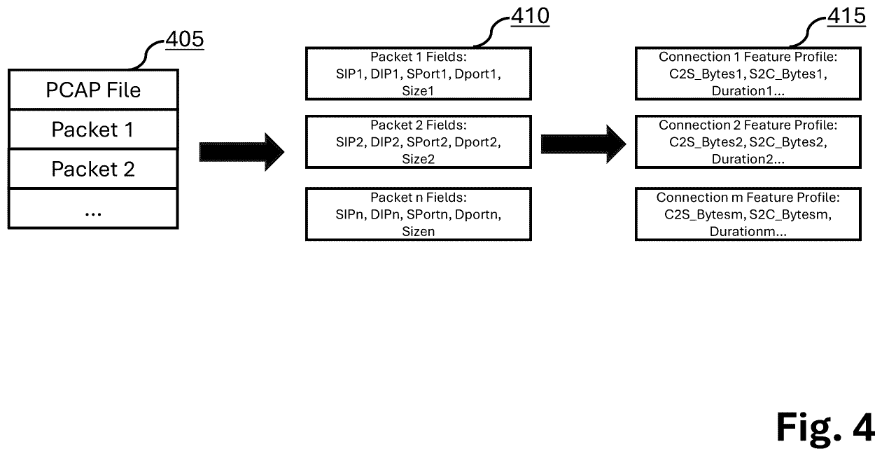

FIG. 4 is a diagram illustrating an example of creating connection profiles from network traffic data. As shown in the figure, FIG. 4 relates to an example of creating connection profiles from network traffic data including PCAP (Packet Capture) files, but the present disclosure is not limited hereto, and aspects of the connection profile creation and anomaly detection are equally applicable to other types of data including log files from servers as well as logs of application system calls.

As described herein, the processor circuitry 140 of the anomaly detection device 110 may receive a set of network traffic data including one or more PCAP files 405. The PCAP file 405 generally refers to a data file format used to store network traffic captured from tools such as Wireshark or tcpdump. The PCAP file 405 may include raw packet data for one or more packets (e.g., packet 1, packet 2) including headers and payloads to allow for analysis of traffic patterns, protocols, and potential security issues.

The processor circuitry 140 extracts a set of data fields 410 from the PCAP file 405. The set of data fields may refer to information defining the structure, source, destination, protocol, or payload of the set of network traffic data. Each data field of the set of data fields may be associated with a data field value. The data field values may refer to the value of a specific attribute of the set of network traffic data. For instance, as shown in FIG. 4, the processor circuitry may extract a set of data fields 410 associated with data field values of source IP address, destination IP address, source port, destination port, and size. The processor circuitry 140 may extract the set of data fields using one or more packet analysis tools, parsing libraries, APIs, command-line processing, custom parsers, or the like.

Next, the processor circuitry 140 separates the set of data fields 410 into a set of connection profiles 415 based on the data field types. Here, the set of connection profiles 415 may refer to data characterizing a logical session between two endpoints (e.g., a connection between a client and a server). The processor circuitry 140 may separate the set of data fields into the set of connection profiles 415 by sorting the set of data fields 410 by type and aggregating data field values of the set of data fields 410 that correspond to an associated connection. As an example, the processor circuitry 140 may identify packets with data fields of source IP address, destination IP Address, source port, destination port, and transport protocol that achieve a similarity criterion (e.g., have the same or similar values, or achieve a cosign similarity threshold), and aggregate the data field values of the data fields for each of the identified packets to obtain the individual connection features that populate the set of connection profiles 415. The connection features of the set of connection profiles 415 may include, for instance, C2S_bytes (client to server bytes), S2C_bytes (server to client bytes), and duration.

As an example, in a case that there are 10 packets identified with data fields of source IP address, destination IP Address, source port, destination port, and transport protocol that achieve a similarity criterion (e.g., the data field values of each packet match those of the other packets), and each packet has a size of 100 bytes, the processor circuitry 140 may sum the size of 100 bytes for each of the 10 packets to obtain a connection feature of “client to server bytes” with a size value of 1000 bytes.

Subsequently, as described herein, the processor circuitry 140 can generate a set of connection feature vectors that represent the set of connection features 415 in a vector format. The processor circuitry 140 may generate the connection feature vector by performing URL extraction with respect to the set of connection profiles 415 to convert non-numeric data to a vector format using an embedding. This process may include extracting relevant components of a URL, such as the domain name, path, query parameters, and subdomains, and then mapping these components to a numerical representation through an embedding model. Various types of embeddings may be used for this purpose, including word embeddings (e.g., Word2Vec, GloVe, or FastText) that capture semantic relationships between textual components, character-level embeddings that process URLs at a finer granularity, and transformer-based embeddings (e.g., BERT or T5) that can capture contextual relationships between different parts of a URL. Additionally, custom-trained embeddings using deep learning models can be employed to learn URL-specific patterns based on labeled datasets of benign and malicious URLs. In this way, both numeric data and non-numeric data can be represented in the connection feature vector, facilitating anomaly detection and classification of web traffic patterns.

Embedding may be performed outside of URL extraction and may be applied to other string-based fields such as user agent strings, filenames, DNS queries, or custom protocol strings. The processor circuitry 140 may use word-based embeddings (e.g., Word2Vec, GloVe), character-level embeddings, or transformer-based embeddings (e.g., BERT) to capture both syntactic and contextual relationships among the extracted strings. This flexibility allows the system to handle a variety of textual data fields found in modern network protocols and to enhance its effectiveness in detecting anomalous or malicious activity based on string-based indicators

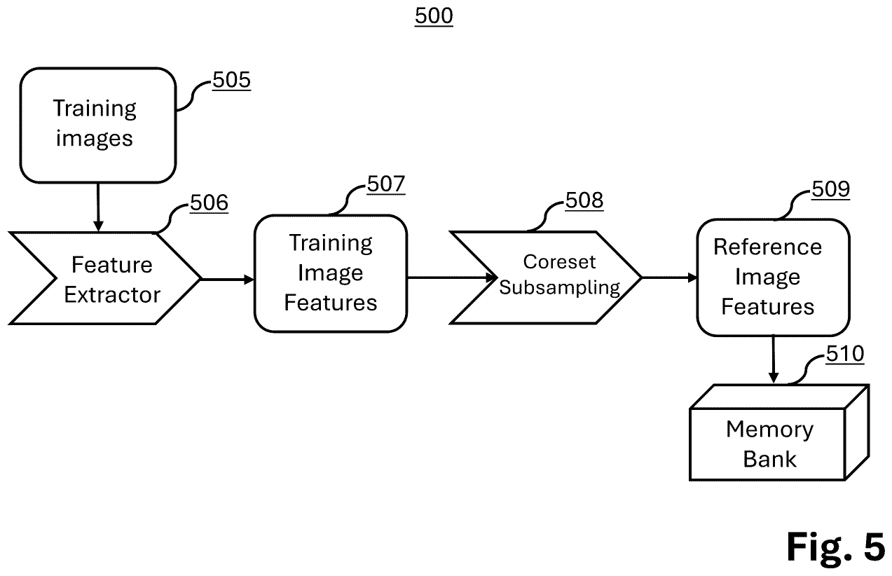

FIG. 5 is block diagram illustrating a neural network model training process 500. The neural network model training process 500 may be used to train a neural network model for anomaly detection. The neural network model trained in the neural network model training process 500 may be used for target image feature extraction and anomaly score calculation in Steps S209, S210 of the anomaly detection method 200 illustrated in FIG. 2.

In embodiments, aspects of the present disclosure relate to performing anomaly detection using an image-based anomaly detection technique such as Patchcore. Examples of other image-based anomaly detection techniques that may be used include Ano-SwinMAE, Sub-Image Anomaly Detection with Deep Pyramid Correspondences (SPADE), AnoGan, Variational Autoencoders, FastFlow, Gaussian Mixture Models, Patch Distribution Modeling, Fully Convolutional Data Description, or the like. However, the anomaly detection technique used herein is not particularly limited, and other suitable techniques will be apparent to one skilled in the art.

First, the processor circuitry 140 of the anomaly detection device 110 may receive a set of training images 505. The set of training images 505 may include images generated based on non-anomalous patterns of network traffic. The set of training images 505 may be obtained by applying the techniques described in Steps S201-S208 of the anomaly detection method 200 illustrated in FIG. 2 with respect to non-anomalous network traffic data. In this way, a set of benign training images can be acquired.

Next, the processor circuitry 140 of the anomaly detection device 110 may extract a set of training image features 507 from patches of the set of training images 505 using a feature extractor 506 of a neural network model. As an example, in the case that Patchcore is used for anomaly detection, a pre-trained convolutional neural network may be used to extract the set of training image features 507 (e.g., using layer 3 of the feature extractor in Patchcore). This set of training features 507 represents the normal, benign network traffic activity represented in the training images 505.

Next, the processor circuitry 140 may perform a coreset subsampling process 508 to select a set of reference image features 509 from among the set of training image features 507. By performing the coreset subsampling process 508 to select a set of reference image features 509 that represent the set of training images 505, it is possible to reduce computational costs (e.g., processor resources, memory resources, storage resources) and increase performance compared to cases in which all of the training image features 507 are stored.

Next, the processor circuitry 140 may create a memory bank 510 for storing a set of reference image features 509. This memory bank 510 can be stored as part of the neural network model for use in anomaly detection.

As described herein, during inference, the neural network model may evaluate new image patches by comparing their extracted features (e.g., the set of target image features) to the set of reference image features 509 stored in the memory bank 510. The neural network model may use an approximate nearest neighbor search to find the closest matching features from among the set of reference image features 509 in the memory bank 510. The anomaly score for each patch may be calculated based on the similarity (or dissimilarity) between the new patch (e.g., the set of target features) and the closest nominal features (e.g., the set of reference features). Additionally, as described herein, by calculating anomaly scores for all patches in an image, it is possible to generate an anomaly map that highlights regions with high anomaly scores. In this way, anomalies can be localized and visualized within the connection image, and particular connection features that contributed to the anomaly can be ascertained.

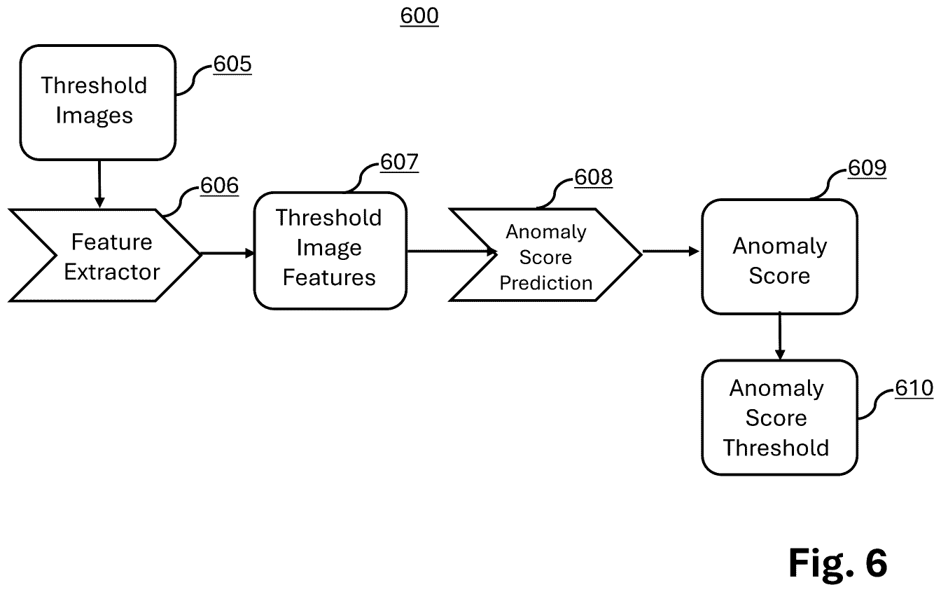

FIG. 6 is a block diagram illustrating an anomaly score threshold determination process 600. The anomaly score threshold determination process 600 may be used for setting the anomaly score threshold(s) used in anomaly detection. The anomaly score threshold(s) determined in the anomaly score threshold determination process 600 may be used in Step S211 and S218 of the anomaly detection method 200 illustrated in FIG. 2.

First, the processor circuitry 140 of the anomaly detection device 110 may receive a set of threshold images 605. The set of threshold images 605 may include images generated based on non-anomalous patterns of network traffic. The set of threshold images 605 may be obtained by applying the techniques described in Steps S201-S208 of the anomaly detection method 200 illustrated in FIG. 2 with respect to non-anomalous network traffic data. In this way, a set of benign threshold images can be acquired. Here, the set of threshold images 605 may be a different set of images than the set of training images 505 used in the neural network model training process 500. More particularly, the set of threshold images 605 may be a set of images unseen by the neural network model.

Next, the processor circuitry 140 of the anomaly detection device 110 may extract a set of threshold image features 607 from patches of the set of threshold images 605 using a feature extractor 606 of a neural network model. As an example, in the case that Patchcore is used for anomaly detection, a pre-trained convolutional neural network may be used to extract the set of threshold image features 607 (e.g., using layer 3 of the feature extractor in Patchcore). This set of threshold features 607 represents the normal, benign network traffic activity represented in the threshold images 605.

In further embodiments, the processor circuitry 140 may adopt alternative statistical or machine-learning-based approaches to determine the first or second anomaly score thresholds. For example, the system may compute an interquartile range (IQR) of the set of predicted anomaly scores, setting the first anomaly threshold to a selected percentile (e.g., the 95th or 99th percentile) of the IQR distribution to minimize false positives. In other implementations, a rolling average of historical anomaly scores over a defined time window could be tracked, and the threshold dynamically updated to reflect changes in typical network traffic behavior.

Next, the processor circuitry 140 of the anomaly detection device 110 may perform anomaly score prediction 608 to calculate a set of predicted anomaly scores 609 for the set of threshold image features 607 with respect to the set of reference image features stored in the memory bank 510. As described herein, the set of predicted anomaly scores 609 for the set of threshold image features 607 with respect to the set of reference image features stored in the memory bank 510 may be generated by using the neural network model to perform an approximate nearest neighbor search to find the closest matching features from among the set of reference image features in the memory bank 510, and subsequently calculating the set of anomaly scores 609 based on the similarity (or dissimilarity) between the set of threshold image features 607 and the closest nominal features (e.g., the set of reference features).

Next, the processor circuitry 140 of the anomaly detection device 110 may set the first anomaly score threshold based on the set of predicted anomaly scores 609 for the set of threshold image features 607. In embodiments, the processor circuitry 140 of the anomaly detection device 110 may set the first anomaly score threshold by applying a statistical criterion with respect to the set of threshold image features 607. More particularly, the processor circuitry 140 may identify the maximum observed anomaly score from among the set of anomaly scores 609, and set the first anomaly score threshold to a value obtained by multiplying the maximum observed anomaly score by a first predetermined constant value (e.g., 1.2). In this way, the first anomaly score threshold can be set to a value high enough to allow for tolerance of some degree of deviation and avoid false positives.

Additionally, in embodiments, the processor circuitry 140 of the anomaly detection device 110 may set the second anomaly score threshold to a value obtained by multiplying the maximum observed anomaly score by a second predetermined constant value greater than the first predetermined constant value (e.g., 1.25, 1.3, 1.4). In embodiments, the second anomaly score threshold may be set such select a fixed percentage (e.g., top 1%, top 5%, top 10%) of connection features associated with the highest anomaly score. In this way, those particular connection features that are particularly anomalous and contribute the most to the anomaly detection may be identified for inclusion in the second notification generated at Step S217 of the anomaly detection method 200 illustrated in FIG. 2

FIG. 7 illustrates example anomaly maps and anomalous connection features for different data exfiltration attack vectors. As described herein, aspects of the disclosure relate to determining anomaly maps and connection features indicating the aspects of the network traffic data connections detected to be anomalous.

More particularly, FIG. 7 illustrates example anomaly maps and anomalous connection features for data exfiltration performed over HTTPS and data exfiltration performed over DNS. As illustrated in FIG. 7, provided original connection images 705a, 705b representing received network traffic data (e.g., as generated using the techniques described in Steps S201-S208 of the anomaly detection method shown in FIG. 2), the processor circuitry 140 of the anomaly detection device 110 may generate anomaly maps 706a, 706b that highlight regions in the connection images 705a, 705b that are associated with anomalous network traffic activity. As shown in FIG. 7, the anomaly maps 706 may be represented as heat maps where cooler colors (e.g., blue) indicate less anomalous network behavior and hotter colors (e.g., red) indicate more anomalous network behavior. The anomaly maps 706 may be overlayed on the respective connection images 705a, 705b to generate overlayed anomaly maps 707a, 707b that indicate the anomalous regions of the anomaly map relative to the original image.

As described herein, as the pixels in the anomaly maps 706a, 706b may be RGB representations of the connection values in the connection matrix, and the connection values in the connection matrix in turn correspond to particular connection features of the connection profile, any region (e.g., patch) of the anomaly maps 706a, 706b can be directly mapped back to one or more particular connection features in the connection profile, and thus the data fields extracted from the network traffic data, based on the position of the corresponding connection values in the connection matrix. Accordingly, the connection features of the connection profile that contributed most to the anomaly detection can be identified. For example, for the anomaly map 706a, anomalous connection features 710a of [sip_encoded, dip_encoded, duration is_daytime] and [pronounced_c2s, pronounced_s2c, pronounced_dip, pronounced_sip] may be identified. Similarly, for the anomaly map 706b, anomalous connection features 710b of [pronounced_sip, c2s_pkt_count, s2c_pkt_count, min_c2s_pkt_size, max_c2s_pkt_size] may be identified.

In this way, it is possible to differentiate between different types of attack vectors. For example, as illustrated in FIG. 7, a data exfiltration attack carried out over DNS has a different attack signature than an attack carried out over HTTPS, with different anomalous feature combinations. Aspects of the present disclosure relate to determining a data signature of the connection profile based on the identified anomalous connection features, and restricting network traffic associated with the determined data signature to one or more computing assets. More particularly, the processor circuitry 140 of the anomaly detection device 110 may determine the data signature of the connection profile by defining a range of connection features (e.g., source/destination IP or MAC addresses, unusual protocol combinations, specific payload characteristics, encrypted communication patterns) for which anomalous behavior was observed in the anomaly map, and configure a security policy for restricting network traffic consistent with the determined data signature. For example, the processor circuitry 140 may block IPs, ports, or protocols associated with the determined data signature, configure an intrusion prevention system to detect and block network traffic that matches the determined data signature, perform deep packet inspection, rate limiting to throttle traffic, establish network segmentation to move a targeted system to an isolated VLAN, or the like.

The anomaly detection device 110 may interface directly with external security systems or appliances to block or quarantine suspicious connections in an automated manner. For example, upon classifying a connection as anomalous, the device 110 may communicate with firewalls, intrusion prevention systems (IPS), or security information and event management (SIEM) platforms, providing them with the relevant connection features or data signatures. The external systems can then update access control lists (ACLs), enact rate-limiting policies, or generate more comprehensive event alerts for system administrators.

It will be recognized that aspects of the present disclosure represent an improvement to the functionality of computing systems by transforming network traffic data to a visual format to leverage advanced image processing techniques to detect anomalies more accurately and effectively than traditional numeric data methods. This makes it possible to improve anomaly detection accuracy by allowing ML models to identify complex, high-dimensional patterns, and enhance cybersecurity defense mechanisms against sophisticated attacks, such as data exfiltration and insider threats. Particularly, the techniques of the present disclosure have proven effective in identifying and preventing cyber-attacks including DNS tunneling through Iodine, HTTP data exfiltration using DET (Data Exfiltration Toolkit), and HTTPS data exfiltration using the Discord API. Further, efficient identification of anomalous network connections allows for computing resources such as processing resources, memory resources, and storage resources to be saved in comparison with conventional methods.

Additionally, image representations of network traffic can allow for better visualization of network traffic patterns, facilitating network monitoring and performance analysis by providing more intuitive representations of traffic behavior. In this way, it is possible to enhance defense mechanisms against malicious actors by improving anomaly detection.

In embodiments, aspects of the present disclosure may be used to detect anomalies dynamically in real-time. For instance, the techniques of the present disclosure could be executed on a network end point, on a network server, gateway, or the like that is configured to periodically analyze network traffic for one or more connections and provide an alert dynamically in real-time when the network traffic exhibits anomalous behavior.

While aspects of the present disclosure have been described with respect to an example of network traffic, the techniques described are not particularly limited herein, and may be utilized to detect anomalies in other contexts. For example, feature vectors may be generated based on system calls to identify anomalies in the execution of an application.

As described herein and shown in FIG. 1, the anomaly detection device 110 includes computer circuitry 115 including a memory 120, a storage unit 130, processor circuitry 140, and input/output units 145. The computer circuitry 115 of the anomaly detection device 110 may include any suitable devices, such as processors (e.g., CPU), programmable circuits, integrated circuits, memory and I/O circuits, application specific integrated circuits, microcontrollers, complex programmable logic devices, other programmable circuits, input/output devices, or the like. The computer circuitry 115 may be located on one or more discrete and separate pieces of hardware. The computer circuitry 115 may also include a non-transitory computer readable medium, such as random-access memory (RAM), a read-only memory (ROM), an erasable programmable read-only memory (EPROM or Flash memory), or any other suitable medium. The memory 120, storage unit 130, processor circuitry 140, and input/output units 145 may be communicatively coupled through a system bus, mother board, or using any other suitable structure known in the art.

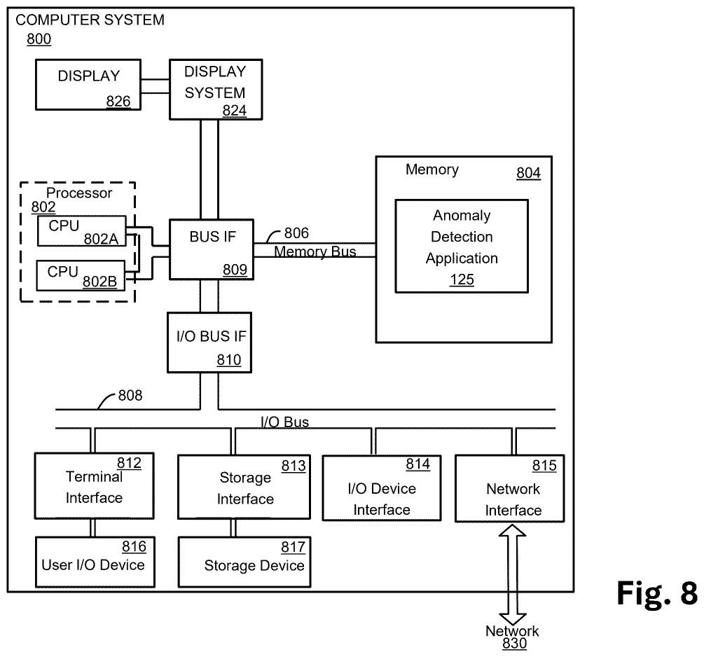

The memory 120 may include a memory for storing an anomaly detection application 125 for implementing the functions of the asset management technique according to the embodiments of the present disclosure. The anomaly detection application 125 may be a computer-readable program configured to be executed by the processor circuitry 140. The processor circuitry 140 may include a processing unit for executing processing instructions for the various software modules and functional units included in the anomaly detection application 125 stored in the memory 120 and may substantially correspond to the processor 802 of the computer system 800 illustrated in FIG. 8. The storage unit 130 may include a unit for storing various data and information used in implementing the aspects of the present disclosure. The storage unit 130 may include a collection of hard disk drives, solid state drives, flash memory, cloud, storage, or the like. The input/output units 145 are a collection of devices for facilitating communication between the anomaly detection device 110 and external sources, such as the one or more client devices 190. In embodiments, the input/output units 145 may include network interfaces, display units, speakers, mice, keyboards, touch screens or the like for facilitating the input and output of information with respect to the anomaly detection device 110.

FIG. 8 depicts a high-level block diagram of a computer system 800 for implementing various embodiments of the present disclosure, according to embodiments. For example, the asset management device as explained below can be implemented by the computer system 800. The mechanisms and apparatus of the various embodiments disclosed herein apply equally to any appropriate computing system. The major components of the computer system 800 include one or more processors 802, a memory 804, a terminal interface 812, a storage interface 813, an I/O (Input/Output) device interface 814, and a network interface 815, all of which are communicatively coupled, directly or indirectly, for inter-component communication via a memory bus 806, an I/O bus 808, bus interface unit 809, and an I/O bus interface unit 810.

The computer system 800 may contain one or more general-purpose programmable central processing units (CPUs) 802A and 802B, herein generically referred to as the processor 802. In embodiments, the computer system 800 may contain multiple processors; however, in certain embodiments, the computer system 800 may alternatively be a single CPU system. Each processor 802 executes instructions stored in the memory 804 and may include one or more levels of on-board cache.

In embodiments, the memory 804 may include a random-access semiconductor memory, storage device, or storage medium (either volatile or non-volatile) for storing or encoding data and programs. In certain embodiments, the memory 804 represents the entire virtual memory of the computer system 800 and may also include the virtual memory of other computer systems coupled to the computer system 800 or connected via a network. The memory 804 can be conceptually viewed as a single monolithic entity, but in other embodiments the memory 804 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 804 may store all or a portion of the various programs, modules, and data structures for processing data transfers as discussed herein. For instance, the memory 804 can store an asset management application 125. In embodiments, the asset management application 125 may include instructions or statements that execute on the processor 802 or instructions or statements that are interpreted by instructions or statements that execute on the processor 802 to carry out the functions as further described below.

In certain embodiments, the asset management application 125 is implemented in hardware via semiconductor devices, chips, logical gates, circuits, circuit cards, and/or other physical hardware devices in lieu of, or in addition to, a processor-based system. In embodiments, the asset management application 125 may include data in addition to instructions or statements. In certain embodiments, a camera, sensor, or other data input device (not shown) may be provided in direct communication with the bus interface unit 809, the processor 802, or other hardware of the computer system 800. In such a configuration, the need for the processor 802 to access the memory 804 and the asset management application 125 may be reduced.

The computer system 800 may include a bus interface unit 809 to handle communications among the processor 802, the memory 804, a display system 824, and the I/O bus interface unit 810. The I/O bus interface unit 810 may be coupled with the I/O bus 808 for transferring data to and from the various I/O units. The I/O bus interface unit 810 communicates with multiple I/O interface units 812, 813, 814, and 815, which are also known as I/O processors (IOPs) or I/O adapters (IOAs), through the I/O bus 808. The display system 824 may include a display controller, a display memory, or both. The display controller may provide video, audio, or both types of data to a display device 826. Further, the computer system 800 may include one or more sensors or other devices configured to collect and provide data to the processor 802.

As examples, the computer system 800 may include biometric sensors (e.g., to collect heart rate data, stress level data), environmental sensors (e.g., to collect humidity data, temperature data, pressure data), motion sensors (e.g., to collect acceleration data, movement data), or the like. Other types of sensors are also possible. The display memory may be a dedicated memory for buffering video data. The display system 824 may be coupled with a display device 826, such as a standalone display screen, computer monitor, television, or a tablet or handheld device display.

In one embodiment, the display device 826 may include one or more speakers for rendering audio. Alternatively, one or more speakers for rendering audio may be coupled with an I/O interface unit. In alternate embodiments, one or more of the functions provided by the display system 824 may be on board an integrated circuit that also includes the processor 802. In addition, one or more of the functions provided by the bus interface unit 809 may be on board an integrated circuit that also includes the processor 802.

The I/O interface units support communication with a variety of storage and I/O devices. For example, the terminal interface unit 812 supports the attachment of one or more user I/O devices 816, which may include user output devices (such as a video display device, speaker, and/or television set) and user input devices (such as a keyboard, mouse, keypad, touchpad, trackball, buttons, light pen, or other pointing device). A user may manipulate the user input devices using a user interface in order to provide input data and commands to the user I/O device 816 and the computer system 800 and may receive output data via the user output devices. For example, a user interface may be presented via the user I/O device 816, such as displayed on a display device, played via a speaker, or printed via a printer.

The storage interface 813 supports the attachment of one or more disk drives or direct access storage devices 817 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 817 may be implemented via any type of secondary storage device. The contents of the memory 804, or any portion thereof, may be stored to and retrieved from the storage device 817 as needed. The I/O device interface 814 provides an interface to any of various other I/O devices or devices of other types, such as printers or fax machines. The network interface 815 provides one or more communication paths from the computer system 800 to other digital devices and computer systems; these communication paths may include, for example, one or more networks 830.

Although the computer system 800 shown in FIG. 8 illustrates a particular bus structure providing a direct communication path among the processors 802, the memory 804, the bus interface 809, the display system 824, and the I/O bus interface unit 810, in alternative embodiments the computer system 800 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 810 and the I/O bus 808 are shown as single respective units, the computer system 800 may, in fact, contain multiple I/O bus interface units 810 and/or multiple I/O buses 808. While multiple I/O interface units are shown which separate the I/O bus 808 from various communications paths running to the various I/O devices, in other embodiments, some or all of the I/O devices are connected directly to one or more system I/O buses.

In various embodiments, the computer system 800 is a multi-user mainframe computer system, a single-user system, or a server computer or similar device that has little or no direct user interface but receives requests from other computer systems (clients). In other embodiments, the computer system 800 may be implemented as a desktop computer, portable computer, laptop or notebook computer, tablet computer, pocket computer, telephone, smart phone, or any other suitable type of electronic device.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed.

Thus, use of the term “or” herein is the inclusive, and not the exclusive use. See, Bryan A. Garner, A Dictionary of Modern Legal Usage 624 (2d. Ed. 1995). Similarly, the term “set” as used herein is intended to include one or more of the designated entity.

To the extent that reference is made to registered trademarks in the detailed description, it will be understood that all registered trademarks are the property of their respective owners.

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

1. An anomaly detection device comprising:
processor circuitry configured to:
receive a set of network traffic data for multiple connections;
extract a set of data fields from the received set of network traffic data, wherein each data field of the set of data fields is associated with a data field value;
separate the set of data fields into a set of connection profiles based on the data field values, wherein each connection profile of the set of connection profiles:
is associated with a connection of the multiple connections:
includes a set of connection features obtained by aggregating the data field values of the set of data fields for the associated connection;
generate a set of connection feature vectors by:
for each connection of the multiple connections, generating a connection feature vector based on the set of connection features for the associated connection;
generate a set of narrowed feature vectors by:
for each connection feature vector of the generated set of connection feature vectors, generating a narrowed feature vector by applying a value narrowing function to the connection feature vector to compress values of the connection feature vector for the associated connection to a defined range;
generate a set of connection matrices by, for each narrowed feature vector of the set of generated narrowed feature vectors:
generating a connection matrix for the associated connection by taking an outer product of the narrowed feature vector with itself, such that:
the generated connection matrix includes a set of connection values, wherein each connection value of the set of connection values comprises an entry in the connection matrix;
each connection value of the set of connection values is computed based on the value of one or more connection features of the narrowed feature vector; and
each connection value of the set of connection values is associated with one or more of the connection features of the set of connection features of the connection profile based on the one or more connection features of the narrowed feature vector used to compute the connection value;
scaling the generated connection matrix using a scaling function configured to scale a range of the connection values in the connection matrix;
generate a set of connection images by:
for each connection matrix of the set of generated connection matrices, generating a connection image by converting the set of connection values of the connection matrix to pixel representations, such that the generated connection image visually represents the connection matrix;
identify a set of target image features for each connection image of the set of connection images by:
applying a feature extractor to each connection image of the set of generated connection images to identify features in the connection image and to extract target image features from the connection image based on the identified features;
for each connection image of the set of connection images, calculate an anomaly score based on the extracted target image features;
for each connection image of the set of connection images, when the calculated anomaly score of the connection image is less than or equal to a first anomaly score threshold, classify the associated connection as non-anomalous;
for each connection image of the set of connection images, when the calculated anomaly score of the connection image is greater than the first anomaly score threshold, classify the associated connection as anomalous; and
output a notification indicating the classification of the associated connection.

2. The anomaly detection device according to claim 1, wherein the set of network traffic data includes a PCAP file or a log file.

3. The anomaly detection device according to claim 1, wherein the value narrowing function is a logarithmic function.

4. The anomaly detection device according to claim 1, wherein the value narrowing function is defined as:
$$np . log 1 p ( v ) = ln ( v + 1 ) ,$$
where v is the connection feature vector.

5. The anomaly detection device according to claim 1, wherein the processor circuitry is further configured to extract target image features from the connection image by:
processing the connection image using a pre-trained convolutional neural network; and
extracting the target image features from patches of the connection image using an intermediate layer of the convolutional neural network, wherein the intermediate layer is configured to capture spatial and contextual information from the patches of the connection image.

6. The anomaly detection device according to claim 1, wherein the processor circuitry is further configured to:
receive a set of training images representing non-anomalous patterns of network traffic behavior;
extract a set of training image features from patches of the set of training images using a feature extractor of the neural network model;
subsample the extracted set of training image features using a coreset selection process to select a set of reference image features representative of the set of training images;
create a memory bank that stores the set of reference image features; and
store the memory bank as part of the neural network model for use in anomaly detection.

7. The anomaly detection device according to claim 6, wherein the processor circuitry is further configured to:
determine, for each target image feature of the set of target image features, a distance value representing a measure of similarity between the target image feature and a corresponding reference image feature of the set of reference image features stored in the memory bank;
identify a subset of the target image features having a distance value that achieves a predetermined distance threshold; and
compute, as the anomaly score, a weighted aggregation of the distance values associated with the identified subset of target image features.

8. The anomaly detection device according to claim 1, wherein the processor circuitry is further configured to:
receive a set of threshold images representing non-anomalous patterns of network traffic behavior;
extract a set of threshold features from patches of the set of threshold images using a feature extractor of the neural network model;
calculate a set of predicted anomaly scores for the set of threshold features with respect to the set of reference image features; and
set the first anomaly threshold based on the set of predicted anomaly scores for the set of threshold features, wherein the first anomaly threshold is determined as a function of the set of threshold features that satisfy a statistical criterion.

9. The anomaly detection device according to claim 1, wherein the processor circuitry is further configured to:
generate an anomaly map that indicates regions of the connection image associated with target image features having anomaly scores greater than the predetermined first anomaly score threshold;
map regions of the anomaly map to the set of connection features of a connection profile of the set of connection profiles based on the position of the connection values associated with the set of connection features in the connection matrix;
identify, from among the set of connection features, a subset of the set of connection features associated with target image features that achieve a predetermined second anomaly score threshold; and
output the identified subset of the set of connection features in the notification.

10. The anomaly detection device according to claim 1, wherein, in response to determining that the set of network traffic data is associated with an anomaly, the processor circuitry is further configured to:
determine a data signature of the connection profile; and
restrict network traffic associated with the determined data signature to one or more computing assets.

11. The anomaly detection device according to claim 1, wherein the processor circuitry is further configured to:
generate the connection feature vector by performing URL extraction with respect to the connection profile to convert non-numeric data to a vector format using an embedding.

12. The anomaly detection device according to claim 1, wherein the processor circuitry is further configured to:
generate the connection image using a predetermined color map.

13. An anomaly detection device comprising:
processor circuitry configured to:
generate a neural network model for anomaly detection by:
receiving a set of training images representing non-anomalous patterns of data behavior;
extracting a set of training image features from patches of the set of training images using a feature extractor of the neural network model;
subsampling the extracted set of training image features using a coreset selection process to select a set of reference image features representative of the set of training images;
creating a memory bank that stores the set of reference image features; and
storing the memory bank as part of a neural network model for use in anomaly detection; and
perform anomaly detection by:
receiving a set of network traffic data for multiple connections;
extracting a set of data fields from the received set of network traffic data, wherein each data field of the set of data fields is associated with a data field value;
separating the set of data fields into a set of connection profiles based on the data field values, wherein each connection profile of the set of connection profiles:
is associated with a connection of the multiple connections:
includes a set of connection features obtained by aggregating the data field values of data fields of the set of data fields for the associated connection;
generating a set of connection feature vectors by:
for each connection of the multiple connections, generating a connection feature vector based on the set of connection features for the associated connection;
generating a set of narrowed feature vectors by:
for each connection feature vector of the generated set of connection feature vectors, generating a narrowed feature vector by applying a value narrowing function to the connection feature vector to compress values of the connection feature vector for the associated connection to a defined range;
generating a set of connection matrices by, for each narrowed feature vector of the set of generated narrowed feature vectors:
generating a connection matrix for the associated connection by taking an outer product of the narrowed feature vector with itself, such that:
the generated connection matrix includes a set of connection values, wherein each connection value of the set of connection values comprises an entry in the connection matrix;
each connection value of the set of connection values is computed based on the value of one or more connection features of the narrowed feature vector; and
each connection value of the set of connection values is associated with one or more of the connection features of the set of connection features of the connection profile based on the one or more connection features of the narrowed feature vector used to compute the connection value;
scaling the generated connection matrix using a scaling function configured to scale a range of the connection values in the connection matrix;
generating a set of connection images by:
for each connection matrix of the set of generated connection matrices, generating a connection image by converting the set of connection values of the connection matrix to pixel representations, such that the generated connection image visually represents the connection matrix;
identifying a set of target image features for each connection image of the set of connection images by:
applying a feature extractor to each connection image of the set of generated connection images to identify features in the connection image and to extract target image features from the connection image based on the identified features;
for each connection image of the set of connection images, calculating an anomaly score based on the extracted target image features;
for each connection image of the set of connection images, when the calculated anomaly score of the connection image is less than or equal to a first anomaly score threshold, classifying the associated connection as non-anomalous;
for each connection image of the set of connection images, when the calculated anomaly score of the connection image is greater than the first anomaly score threshold, classifying the associated connection as anomalous; and
outputting a notification indicating the classification of the associated connection.

14. The anomaly detection device according to claim 13, wherein the processor circuitry is further configured to:
receive a set of training images representing non-anomalous patterns of network traffic behavior;
extract a set of training image features from patches of the set of training images using a feature extractor of the neural network model;
subsample the extracted set of training image features using a coreset selection process to select a set of reference image features representative of the set of training images;
create a memory bank that stores the set of reference image features; and
store the memory bank as part of the neural network model for use in anomaly detection.

15. The anomaly detection device according to claim 13, wherein the processor circuitry is further configured to:
generate an anomaly map that indicates regions of the connection image associated with target image features having anomaly scores greater than the predetermined first anomaly score threshold;
map regions of the anomaly map to the set of connection features of a connection profile of the set of connection profiles based on the position of the connection values associated with the set of connection features in the connection matrix;
identify, from among the set of connection features, a subset of the set of connection features associated with target image features that achieve a predetermined second anomaly score threshold; and
output the identified subset of the set of connection features in the notification.

16. An anomaly detection method to be implemented by an anomaly detection device, the anomaly detection method comprising:
receiving, using processor circuitry of the anomaly detection device, a set of network traffic data for multiple connections;
extracting, using processor circuitry of the anomaly detection device, a set of data fields from the received set of network traffic data, wherein each data field of the set of data fields is associated with a data field value;
separating, using processor circuitry of the anomaly detection device, the set of data fields into a set of connection profiles based on the data field values, wherein each connection profile of the set of connection profiles:
is associated with a connection of the multiple connections:
includes a set of connection features obtained by aggregating the data field values of data fields of the set of data fields for the associated connection;
generating, using processor circuitry of the anomaly detection device, a set of connection feature vectors by:
for each connection of the multiple connections, generating a connection feature vector based on the set of connection features for the associated connection;
generating, using processor circuitry of the anomaly detection device, a set of narrowed feature vectors by:
for each connection feature vector of the generated set of connection feature vectors, generating a narrowed feature vector by applying a value narrowing function to the connection feature vector to compress values of the connection feature vector for the associated connection to a defined range;
generating, using processor circuitry of the anomaly detection device, a set of connection matrices by, for each narrowed feature vector of the set of generated narrowed feature vectors:
generating a connection matrix for the associated connection by taking an outer product of the narrowed feature vector with itself, such that:
the generated connection matrix includes a set of connection values, wherein each connection value of the set of connection values comprises an entry in the connection matrix;
each connection value of the set of connection values is computed based on the value of one or more connection features of the narrowed feature vector; and
each connection value of the set of connection values is associated with one or more of the connection features of the set of connection features of the connection profile based on the one or more connection features of the narrowed feature vector used to compute the connection value;
scaling the generated connection matrix using a scaling function configured to scale a range of the connection values in the connection matrix;
generating, using processor circuitry of the anomaly detection device, a set of connection images by:
for each connection matrix of the set of generated connection matrices, generating a connection image by converting the set of connection values of the connection matrix to pixel representations, such that the generated connection image visually represents the connection matrix;
identifying, using processor circuitry of the anomaly detection device, a set of target image features for each connection image of the set of connection images by:
applying a feature extractor to each connection image of the set of generated connection images to identify features in the connection image and to extract target image features from the connection image based on the identified features;
for each connection image of the set of connection images, calculating, using processor circuitry of the anomaly detection device, an anomaly score based on the extracted target image features;
for each connection image of the set of connection images, when the calculated anomaly score of the connection image is less than or equal to a first anomaly score threshold, classifying, using processor circuitry of the anomaly detection device, the associated connection as non-anomalous;
for each connection image of the set of connection images, when the calculated anomaly score of the connection image is greater than the first anomaly score threshold, classifying, using processor circuitry of the anomaly detection device, the associated connection as anomalous; and
outputting, using processor circuitry of the anomaly detection device, a notification indicating the classification of the associated connection.

17. The anomaly detection method according to claim 16, further comprising:
receiving, using processor circuitry of the anomaly detection device, a set of training images representing non-anomalous patterns of network traffic behavior;
extracting, using processor circuitry of the anomaly detection device, a set of training image features from patches of the set of training images using a feature extractor of the neural network model;
subsampling, using processor circuitry of the anomaly detection device, the extracted set of training image features using a coreset selection process to select a set of reference image features representative of the set of training images;
creating, using processor circuitry of the anomaly detection device, a memory bank that stores the set of reference image features; and
storing, using processor circuitry of the anomaly detection device, the memory bank as part of the neural network model for use in anomaly detection.

18. The anomaly detection method according to claim 17, further comprising:
determining, using processor circuitry of the anomaly detection device, for each target image feature of the set of target image features, a distance value representing a measure of similarity between the target image feature and a corresponding reference image feature of the set of reference image features stored in the memory bank;
identifying, using processor circuitry of the anomaly detection device, a subset of target image features having a distance value that achieves a predetermined distance threshold; and
computing, using processor circuitry of the anomaly detection device, as the anomaly score, a weighted aggregation of the distance values associated with the identified subset of target image features.

19. The anomaly detection method according to claim 16, further comprising:
receiving, using processor circuitry of the anomaly detection device, a set of threshold images representing non-anomalous patterns of network traffic behavior;
extracting, using processor circuitry of the anomaly detection device, a set of threshold features from patches of the set of threshold images using a feature extractor of the neural network model;
calculating, using processor circuitry of the anomaly detection device, a set of predicted anomaly scores for the set of threshold features with respect to the set of reference image features; and
setting, using processor circuitry of the anomaly detection device, the first anomaly threshold based on the set of predicted anomaly scores for the set of threshold features, wherein the first anomaly threshold is determined as a function of the set of threshold features that satisfy a statistical criterion.

20. The anomaly detection method according to claim 16, further comprising:
generating, using processor circuitry of the anomaly detection device, an anomaly map that indicates regions of the connection image associated with target image features having anomaly scores greater than the predetermined first anomaly score threshold;
mapping, using processor circuitry of the anomaly detection device, regions of the anomaly map to the set of connection features of a connection profile of the set of connection profiles based on the position of the connection values associated with the set of connection features in the connection matrix;
identifying, using processor circuitry of the anomaly detection device, from among the set of connection features, a subset of the set of connection features associated with target image features that achieve a predetermined second anomaly score threshold; and
outputting, using processor circuitry of the anomaly detection device, the identified subset of the set of connection features in the notification.
